(19) United States
(12) Patent Application Publication
(10) Pub. No.: US 2008/0078741 A1
(43) Pub. Date: Apr. 3, 2008

(54) Method for manufacturing optical element

(75) Inventor: Kyoko Kotani, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/892,081

(22) Filed: Aug. 20, 2007

(30) Foreign Application Priority Data
Sep. 29, 2006 (JP) 2006-270090

(51) Int. Cl. B44C 1/22

(52) U.S. Cl. 216/41

(57) ABSTRACT

Forming a resist pattern on a substrate by patterning a resist layer using a photomask. The photomask comprises a mask substrate and a plurality of mask cells arranged in matrix form and in close contact with each other. Each of the mask cells has one or both of a light transmission region and a light-shielding region formed by a light-shielding film provided at the mask substrate. A light intensity of light that is transmitted through the mask cells is a normalized light intensity, and the light intensity of the light that is transmitted through the plurality of mask cells varies. The patterning of the substrate is performed using the resist pattern as an etching mask.

### BACKGROUND OF THE INVENTION

1. Field of the Invention

The present invention relates to a micro optical element, and more particularly to a manufacturing method for DOE (Diffractive Optical Elements) that is formed by processing a substrate such as a silicon substrate.

2. Description of Related Art

A diffractive optical element is used to provide a lens, branching/combining elements, a light intensity distribution conversion element, a wavelength filter, elements for forming various diffractive patterns, and so on. A diffractive optical element controls incident light using a diffractive phenomenon. In a diffractive optical element, a grating formed on a curved surface in particular is approximated by a plurality of minute stepped structural units.

Elements having various different shapes are known as this type of diffractive optical element. In consideration of logical diffractive efficiency, a diffractive optical element is preferably formed from a plurality of continuously arranged saw teeth-shaped structural units forming a smooth curved surface when viewed as a cross-section.

However, it is extremely difficult to manufacture a diffractive optical element having a complicated constitution in which a plurality of saw teeth-shaped structural units are arranged in series.

For example, Japanese Unexamined Patent Application Publication 11-14813 and Hironori SASAKI et al, “Packaging Technologies for Precise Alignment of Light Sources and Silicon Microlenses”, Japan Institute of Electronics Packaging Journal, 2002, Vol. 5, No. 5, P466-472, disclose so-called wafer processes, or in other words methods of applying a photolithography process and an etching process to form a plurality of structural units having a stepped cross-section in series on a silicon substrate, and thereby approximately reproducing the optical characteristics of a diffractive optical element.

According to the manufacturing method for a diffractive optical element disclosed in these publications, m (where m is a natural number) photomasks are used to perform an exposure process, a development process, and an etching process. By repeating this series of processes m times, a diffractive optical element having a stepped sectional form with 2^{m} steps is manufactured.

When this diffractive optical element is seen in cylindrical form, or in other words when an upper surface side thereof is seen in planar form from above, a plurality of annular structural units, each having a different diameter, are disposed concentrically.

To manufacture a diffractive optical element having such the above mentioned structure, a plurality of photomasks must be used, and a series of processes constituted by an exposure process, a development process, and an etching process must be repeated a plurality of times.

Hence, mask pattern superposing using an alignment mark, for example, may be unsuccessful between the former and the later exposure processes, and as a result, the etching position may deviate in each etching process. In such a case, the shape of the formed pattern deviates from the planned shape, thus affecting the optical characteristics of the formed diffractive optical element.

Furthermore, it is extremely difficult to form a diffractive optical element having provided thereat structural units with different numbers of steps coexist.

### SUMMARY OF THE INVENTION

To solve this problem, the inventor of the present invention performed committed research and came to the following conclusions.

(i) Using a resist pattern having an irregular surface, i.e., a concave and convex surface that corresponds to an irregular surface of the optical element to be formed by etching will enable formation of the optical element in a single etching process.

(ii) Exposing a resist layer using exposure light having a light intensity that depends on the height of the irregular surface will result in the resist pattern described above.

(iii) This exposure light will be obtained through advance design to ensure that the light intensity of light transmitted through a photomask takes a value corresponding to the height position of the irregular surface.

Hence, a first preferred embodiment of an optical element manufacturing method according to the present invention includes the following steps.

First, a substrate is prepared.

Next, a resist pattern is formed on the substrate using a photolithography technique. In other words, patterning including exposure processing is performed using an exposure photomask for forming the resist pattern. The photomask comprises a mask substrate and a plurality of mask cells arranged in matrix form and in close contact with each other, and each of the mask cells has one or both of a light transmission region and a light-shielding region formed by a light-shielding film provided at the mask substrate. The light intensity of light transmitted through the mask cells is a normalized light intensity that is variable for each mask cell.

Patterning is then performed on the substrate using the resist pattern as an etching mask.

The resist pattern used here preferably has a pattern structure including a cone- or dome-shaped resist structure on the substrate and at least one wall-like resist structural units provided concentrically on the outside of the resist structure so as to surround the resist structure.

The photomask used to form the resist pattern preferably has the following structural features.

Firstly, the photomask has a mask structure for forming a resist pattern including a cone- or dome-shaped resist structure on the substrate and a plurality of cylindrical resist structural units provided on the outside of the resist structure.

(i) The film thickness of the resist structure decreases sequentially in steps in a radial direction from a first step at a central point thereof toward a final step on the outer periphery thereof.

(ii) Each of the resist structural units is disposed concentrically with the resist structure, and the film thickness thereof decreases sequentially in steps in a radial direction from a first step on the resist structure side toward a final step on the outer periphery thereof.

The photomask used to form this resist pattern has the following features in addition to the structural features described above.

When a light intensity contributing to the formation of the respective first steps of the resist structure and the resist structural units is a first light intensity, and a light intensity contributing to the formation of the final step of each of the resist structural units is a final step light intensity, the mask cells are arranged such that the light intensity increases in stepped fashion by discrete values from the first light intensity to the final step light intensity.

By setting the intensity of the light that is transmitted through the respective mask cells of the photomask such that the relationship described above is established, a resist pattern such as that described above, having a resist structure and resist structural units with a film thickness that varies in stepped fashion, can be formed.

In an embodiment of the present invention, the first light intensity for forming the resist structure and the first light intensity for forming the resist structural units are preferably identical. In so doing, the height, or in other words the film thickness, of the respective first steps of the resist structure and resist structural units from the substrate surface can be the same.

Further, according to a preferred embodiment of the present invention, the rate of change in the light intensity of the resist structure and resist structural units is preferably made identical.

Further, the number of steps at which the light intensity is varied and the rate of change in the light intensity at each step may be varied in accordance with design requirements with respect to the transmission light for forming the resist structure and the transmission light for forming the respective resist structural units, the transmission light for forming the resist structural units, the transmission light for forming one of the resist structural units, and the transmission light for forming the plurality of resist structural units.

According to another preferred embodiment of the manufacturing method for a diffractive optical element described above, the length of one side of the mask cell may be set to be shorter than a length serving as a resolution limit of an optical system of an exposure apparatus using the photomask.

In so doing, the height of the resist pattern can be made to vary more smoothly in a non-stepped fashion, and as a result, the resist pattern surface can be made to approximate a spherical crown-shaped curved surface, a conical surface, or a flat inclined surface more precisely.

### BRIEF DESCRIPTION OF THE DRAWINGS

The foregoing and other objects, features and advantages of the present invention will be better understood from the following description taken in connection with the accompanying drawings, in which:

FIGS. 1(A), 1(B) and 1(C) are schematic diagrams illustrating a constitutional example of a photomask, FIG. 1(A) being a plan view in which a part of the photomask is seen from above, FIG. 1(B) being a view showing a cross-section taken along an A-A line in FIG. 1(A), and FIG. 1(C) being a view illustrating a relationship between a position in a direction (X direction) extending along the A-A line in FIG. 1(A) and the light intensity of transmission light, the abscissa of FIG. 1(C) showing the position in the X direction and the ordinate showing the light intensity of the transmission light;

FIG. 2 is a graph showing a relationship between a width of a light transmission region and a film thickness of a remaining resist pattern in one pitch when exposure and development are performed using the photomask;

FIG. 3(A) is a schematic diagram illustrating a constitutional example of a light transmission region and a light shielding region set on a mask cell that is suitable for application to a manufacturing process of this example, and FIG. 3(B) is a view showing a resist film thickness corresponding to the mask cell of FIG. 3(A);

FIG. 4(A) is a schematic plan view showing a constitutional example of a diffractive optical element omitting each step, and FIG. 4(B) is a schematic diagram showing a sectional end surface taken along a straight line I-I′ that passes through the center of the diffractive optical element shown in FIG. 4(A);

FIG. 5(A) is a schematic plan view showing constitutional example of resist structural units, and FIG. 5(B) is a schematic diagram showing a sectional end surface cut along a straight line I-I′ that passes through the center of the resist structural units shown in FIG. 5(A).

FIG. 6(A) is a schematic diagram showing a sectional end surface cut along a straight line that passes through the center of the diffractive optical element, and FIG. 6(B) is a schematic diagram showing a sectional end surface cut along a straight line I-I′ that passes through the center of the diffractive optical element shown in FIG. 6(A).

FIG. 7 is a schematic plan view showing a constitutional example of resist structural units during manufacture of the diffractive optical element; and

FIG. 8 is a schematic plan view showing a constitutional example of resist structural units during manufacture of the diffractive optical element.

### DESCRIPTION OF THE PREFERRED EMBODIMENTS

With reference to the drawings, preferred embodiments of the present invention will be described below. The drawings merely provide a schematic view of the shape, size, and dispositional relationships of the constituent components to an extent permitting an understanding of the present invention, there being no intention to limit the present invention to the illustrated example. Further, in the following description, although specific materials and conditions and so forth are sometimes employed, these materials and conditions constitute no more than one preferred example, and hence the present invention is in no way limited to or by such an example. Further, the same numerals will be shown allocated to the same constituent components in the drawings so that repetitive description will also be avoided.

(Photomask)

First, a constitutional example of a photomask suitable for application to the method for manufacturing a diffractive optical element of preferred embodiments according to the present invention will be described.

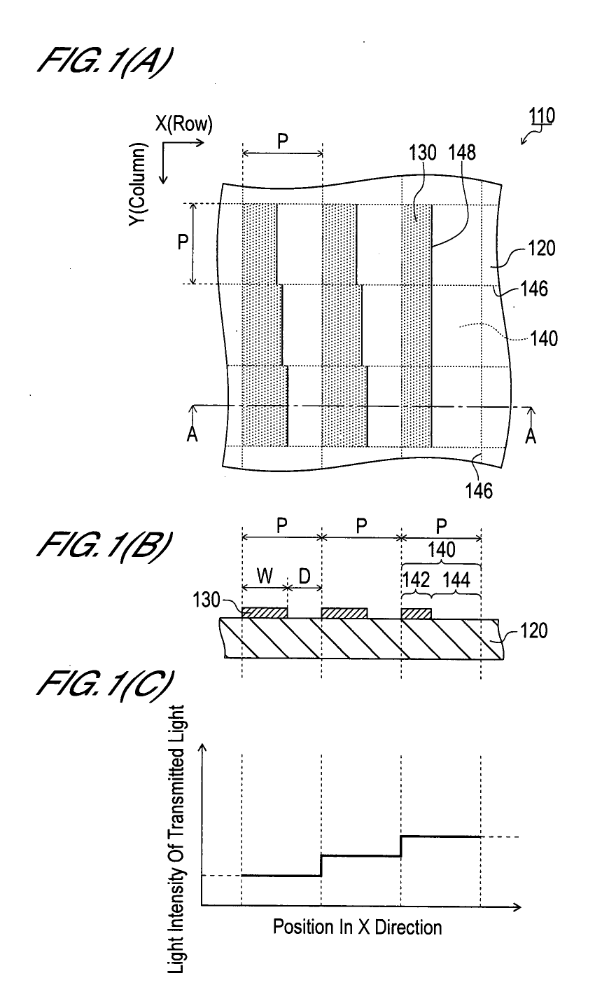

Referring to FIGS. 1(A), 1(B) and 1(C), the constitution of a photomask for forming a resist pattern, which is applied to the diffractive optical element manufacturing method of the present embodiment, will be described.

A photomask 110 has a plurality of mask cells 140 set on a substrate 120. The mask cells 140 are preferably constituted by a plurality of identically sized squares set on a transparent mask substrate 120 made of quartz glass or the like. The mask cells 140 are preferably set in a plurality of unit mask cell regions defined on one main surface of the mask substrate 120, respectively.

These unit mask cell regions are provided adjacent to and in close contact with each other. For example, the unit mask cell regions may be regions that are set by partitioning, at equal intervals, one main surface of the mask substrate 120 by means of a plurality of virtual grid lines 146, which include one straight line drawn in an X direction (or row direction) and the other straight lines drawn in a Y direction (or a column direction), these X and Y straight lines being orthogonal to each other. Hence, in this case, the unit mask cell regions are arranged in a matrix arrangement, or preferably an orthogonal matrix arrangement.

Either one or both of a light transmission region 144 and a light-shielding region 142 is set in the mask cell 140.

Alight-shielding film 130 formed through chrome deposition or the like, for example, is preferably provided in the light-shielding region 142 on the mask substrate 120. Alternatively, and if possible, a non-transparent substrate may be used as the mask substrate 120, and the light transmission region 144 may be formed as an opening provided so as to penetrate the substrate. The mask cell 140 is a basic unit for controlling the light intensity of light passing through the photomask 110.

In the case of mask cells 140 having the same surface area, the intensity of the light transmitted through the mask cells 140 depends on the surface area ratio of the light transmission region 144 to the mask cell 140. In other words, as the surface area of the light transmission region 144 of the mask cell 140 increases, the intensity of the light transmitted through the mask cell 140 increases (see FIG. 1(C)).

Here, among the mask cells, when the mask cells arranged continuously in the column direction have a light-shielding region, the light-shielding regions are provided continuously so as to be connected in sequence in the column direction (see FIG. 1(A)).

Further, when the mask cells arranged continuously in the row direction, from among the plurality of mask cells, have a light transmission region and a light-shielding region, the light-shielding regions are not connected in sequence in the row direction (see FIG. 1(A)).

Note that FIG. 1(A) shows an example in which the mask cells 140 set with both the light transmission region 144 and the light shielding region 142 are divided into two zones by a virtual dividing line 148 in the Y direction, with the light transmission region 144 set on one zone of the virtual dividing line 148 (in the drawing, the right side of the virtual dividing line) and the light-shielding region 142 set on the other zone (in the drawing, the left side of the virtual dividing line).

Also note that in each mask cell, the light transmission region 144 is preferably set on the same side of the virtual dividing line 148. The reason for this will be described below.

In a region in which a resist pattern film thickness is constant, mask cells 140 having an identical light intensity may be set continuously.

When the light transmission region 144 is set on the same side of the virtual dividing line 148 in each mask cell 140, the light-shielding region of the mask cells 140 having an identical light intensity and provided continuously in the Y direction forms a single rectangle region.

The mask pattern of the photomask depends on the rectangular shape of the light-shielding film provided in each mask cell. Hence, when light-shielding films 130 of the mask cells 140 are formed all at once regardless of same or differences in shape, the time required to manufacture the photomask can be shortened and costs can be reduced.

FIGS. 1(A) and 1(B) show an example in which all of the mask cells 140 are set with the light transmission region 144 and the light-shielding region 142, but the embodiment is not limited to this example.

Specifically, the photomask 110 may comprise mask cells set with only the light transmission region 144, or in other words without the light-shielding region, and mask cells 140 set with only the light-shielding region 142, or in other words without the light transmission region.

In certain cases, a length (also referred to as ‘mask pitch’ hereafter) P of one side of the mask cell 140 may be made smaller than a length serving as the resolution limit of an optical system in an exposure apparatus in which the photomask 110 is used. In this case, when exposure processing is performed on a resist layer using the photomask 110, sufficient contrast for resolving the mask pattern of the photomask, in particular the boundary between the light transmission region and the light-shielding region, cannot be obtained.

Hence in this case, when development is performed after the resist layer is exposed using the photomask 110, the resist layer, which is coated onto the substrate, for example, can be formed into a resist pattern having a film thickness that varies smoothly and continuously, without steps, at the aforementioned boundary, and as a result, the surface of the resist pattern forms a curved surface or a nearly curved surface, a flat surface or a nearly flat surface, a conical surface or a nearly conical surface.

When a so-called i-line stepper having a wavelength λ of 365 nm and a reduced projection magnification of 5, for example, is used as the exposure apparatus, the resolution performance of the exposure optical system depends on an aperture NA of a projection lens and a coherence factor σ.

Table 1 shows the dependency of an optical contrast M on the pitch, numerical aperture NA, and coherence factor σ. Here, the ratio between a width D of the light transmission region (space) 144 and a width W of the light-shielding region (line) 142 is set at 1:1.

The pitch corresponds to a length obtained by projecting the mask pitch P onto the upper surface of the resist layer. When the reduced projection magnification is 5, the pitch is ⅕ of the mask pitch P.

The optical contrast M is expressed by M=(Imax−Imin)/(Imax+Imin). The light intensity of the light that passes through the photomask varies in sine wave form. A maximum value of the light intensity within one period is Imax, and the minimum value is Imin.

TABLE 1

| | NA | | | | | | | | |
|---|---|---|---|---|---|---|---|---|---|
| | 0.50 | | | 0.55 | | | 0.60 | | |
| Pitch | δ | | | | | | | | |
| (nm) | 0.3 | 0.5 | 0.7 | 0.3 | 0.5 | 0.7 | 0.3 | 0.5 | 0.7 |
| 400 | 0 | 0 | 0 | 0 | 0 | 0.02 | 0 | 0 | 0.15 |
| 500 | 0 | 0.03 | 0.22 | 0 | 0.25 | 0.40 | 0.20 | 0.46 | 0.55 |
| 600 | 0.19 | 0.46 | 0.55 | 0.57 | 0.67 | 0.69 | 0.87 | 0.84 | 0.81 |

Typically, the resolving power of an exposure optical system is commensurate with λ/NA. Hence, as the wavelength shortens or the numerical aperture NA increases, the pitch at which the optical contrast M reaches 0, or in other words the pitch at which sufficient contrast for resolving the mask pattern of the photomask cannot be obtained, becomes smaller.

For example, if the pitch on the resist layer upper surface equals or falls below 480 nm (the mask pitch P being 2.4 μm) in cases where the numerical aperture NA is 0.50 and the coherence factor σ is 0.5, the optical contrast M of the light intensity of the transmission light projected onto the wafer reaches 0.

However, the optical contrast M is not limited to 0, and as long as the effect of the optical contrast M on the resist material is within an allowable range, the occurrence of a slight optical contrast M may be accepted.

For example, if the pitch is set at 500 nm in cases where the numerical aperture NA is 0.50 and the coherence factor σ is 0.5, the optical contrast M reaches 0.03, but in this case, the effect of the optical contrast M on the resist material is within the allowable range.

As already described, the upper limit of the mask pitch P is determined depending on the magnitude at which the optical contrast M reaches 0 in accordance with the exposure optical system.

Meanwhile, the shorter the mask pitch P, the higher the resolution in the horizontal direction. However, it is technically difficult to reduce the width D of the light transmission region 144 and the width W of the light-shielding region 142 while enabling manufacture as a photomask. When the width D of the light transmission region 144 and the width W of the light-shielding region 142 are fixed at minimum values and the length P of one side of the mask cell 140 is reduced, the variable width of the light intensity decreases.

For example, when the pitch of the resist pattern is 480 nm, the minimum dimension of the resist pattern within a usable mask manufacturing technique is 150 nm.

Note that in the following description, when there is no indication to the contrary, dimensions converted into dimensions on the resist pattern are used. The dimensions on the photomask may be obtained by multiplying a dimension on the resist pattern by the reduced projection magnification, i.e. 5. At this time, the space width, or in other words the width of the light transmission region converted into a resist pattern dimension, may be set between 150 nm and 330 nm.

Meanwhile, when the pitch is 400 nm, the minimum dimension within a usable mask manufacturing technique is set at 150 nm. Here, the settable space width is within a range of 150 nm to 250 nm.

The number of gradations of the light when the space width is controlled in 1 nm units is 181 when the pitch is 480 nm and 101 when the pitch is 400 nm.

When the pitch is small, the number of gradations of light, or in other words the resolution of the light intensity, falls. Further, the aperture area ratio within the cell is within a range of 31% to 69% when the pitch is 480 nm, and within a range of 38% to 63% when the pitch is 400 nm. In other words, when the pitch is small, the variable width of the light intensity narrows.

When a high precision mask manufacturing technique is employed, or in other words when the minimum dimension is reduced in the mask manufacturing technique, the pitch on the resist pattern can be reduced while maintaining an equal number of gradations.

For example, when the pitch is set at 300 nm and the minimum dimension on the resist pattern is 70 nm, the settable space width is within a range of 70 nm to 230 nm. In this case, when control is performed in 1 nm units, the number of gradations is 161.

However, the reduction of the minimum dimension leads to an increase in the cost of the mask. Therefore, optimum conditions should be selected for the pitch on the resist pattern, taking into consideration the subject pattern, the exposure optical system, the minimum dimension of the mask manufacturing technique, and the mask cost. When the magnitude of the subject resist pattern is sufficiently large, i.e. from tens of μm to hundred μm, the pitch on the resist pattern is preferably set within a range of 400 nm to 500 nm.

According to the photomask for forming a resist pattern described above, the intensity of the transmission light can be set for each mask cell. Hence, when forming a resist pattern on a flat surface in an arbitrary shape having stepped portions, for example an arbitrary shape in which the resist film thickness is unequal in locations having an equal distance from the center or the like, the required photomask can be obtained easily.

When forming a resist pattern using the optical element manufacturing method of the present embodiment, a photomask of a suitable size for application has a pitch of 400 nm, a minimum space width, or in other words a light transmission region width, of 120 nm, and a maximum space width of 280 nm, for example.

Note that the exposure processing may be performed using a well-known i-line stepper. An example of an i-line stepper suitable for application is NSR-2205i11D (product name), manufactured by Nikon Corporation (to be referred to simply as i-line stepper A hereafter). Further, an example of a resist material suitable for application is IX410, manufactured by JSR Corporation (to be referred to simply as resist material A hereafter).

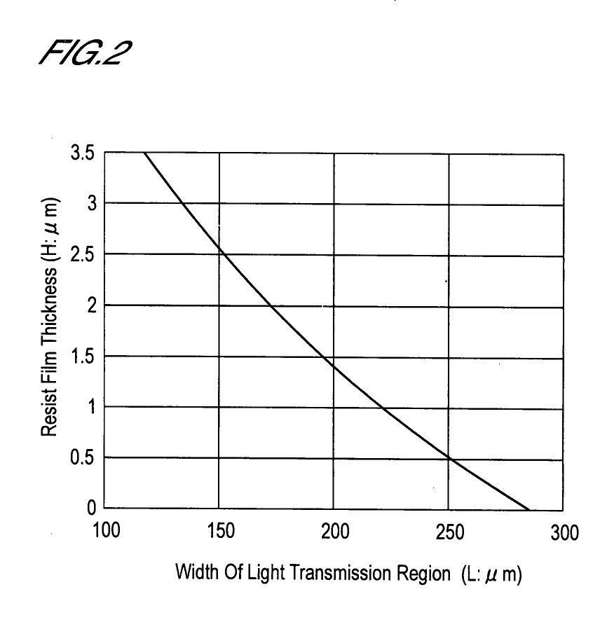

FIG. 2 shows, in the form of a graph, a relationship between the width of the light transmission region of one pitch and the film thickness of the remaining resist pattern when exposure and development are performed using the photomask and the resist material A described above.

As the width of the light transmission region increases, the film thickness of the remaining resist pattern decreases.

It is evident from this relationship between the width of the light transmission region and the film thickness of the remaining resist pattern that the arrangement of the mask cells 140 of the photomask 110 can be optimized such that a predetermined resist pattern shape is obtained.

In the photomask 110 that is suitable for application to the optical element manufacturing process of the present embodiment, the light intensity of the light transmitted through the mask cells 140 may be set at a normalized light intensity. When the intensity of the light that passes through any one of the large number of mask cells is at a maximum, the normalized light intensity is a value of the intensity of the light that passes through the other mask cells, which is determined with the maximum light intensity as 1. Accordingly, the normalized light intensity is a value between, and including, 1 and 0. The normalized light intensity allocated to each mask cell is determined through design, taking into account the height variation of the structure to be formed by etching and the resist pattern to be formed for obtaining the structure.

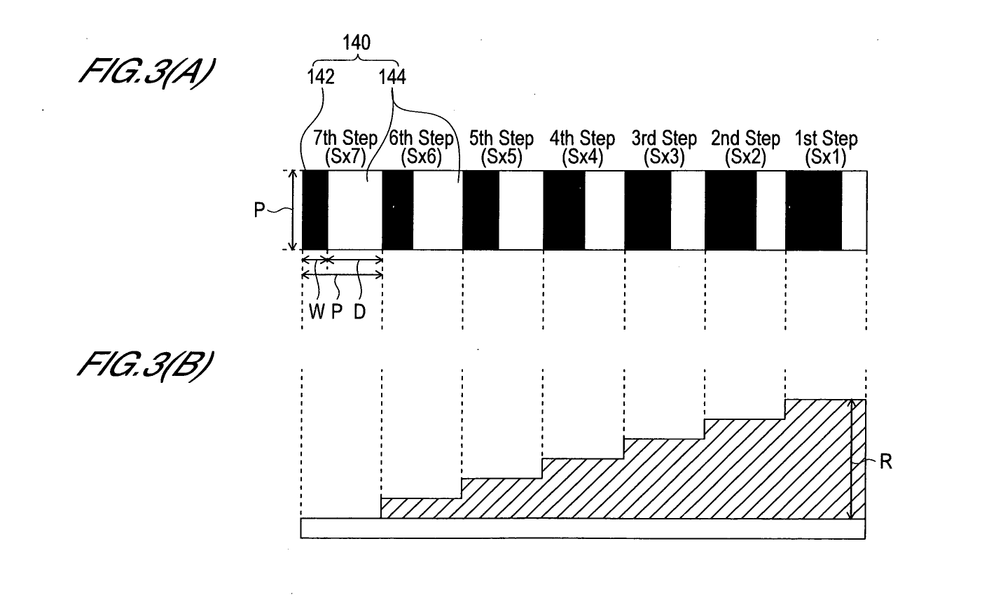

Referring to FIG. 3 and Table 2, detailed explanation will be given to the relationship between the width W of the light transmission region and the width D of the light-shielding region of the mask cell, and a film thickness R of the remaining resist pattern, when the resist material A is used. In the example described here, a resist pattern structure having seven gradations from a first step to a seventh step, or in other words a seven-step resist pattern structure, is formed.

FIG. 3(A) is a schematic diagram illustrating a constitutional example of the light transmission region 144 and light-shielding region 142 set on a mask cell 140 suitable for application to the manufacturing process of this embodiment, and FIG. 3(B) is a view schematically showing the resist film thickness corresponding to each gradation, or in other words each step, in pattern form.

Table 2 shows the relationship between the width D of the light transmission region 144 corresponding to each step and the film thickness R of a remaining resist on a substrate. Note that the pitch P is 400 nm.

TABLE 2

| | Light Transmission | Remaining Resist |
|---|---|---|
| | Region (D) | Film Thickness (R) |
| Step | (nm) | (μm) |
| 7th Step | 290 | 0 |
| 6th Step | 250 | 0.55 |
| 5th Step | 220 | 1.1 |
| 4th Step | 190 | 1.65 |
| 3rd Step | 160 | 2.2 |
| 2nd Step | 140 | 2.75 |
| 1st Step | 120 | 3.3 |

As shown in FIG. 3(B) and Table 2, the width D of the light transmission region 144 corresponding to a seventh step (Sx7) is 290 nm, and in this case, the remaining resist film thickness R is 0 (zero). In other words, no resist remains, and a surface 20a of a substrate 20 is exposed.

The width D of the light transmission region 144 corresponding to a sixth step (Sx6) is 250nm, and in this case, the remaining resist film thickness R is 0.55 μm.

The width D of the light transmission region 144 corresponding to a fifth step (Sx5) is 220 nm, and in this case, the remaining resist film thickness R is 1.1 μm.

The width D of the light transmission region 144 corresponding to a fourth step (Sx4) is 190 nm, and in this case, the remaining resist film thickness R is 1.65 μm.

The width D of the light transmission region 144 corresponding to a third step (Sx3) is 160 nm, and in this case, the remaining resist film thickness R is 2.2 μm.

The width D of the light transmission region 144 corresponding to a second step (Sx2) is 140 nm, and in this case, the remaining resist film thickness R is 2.75 μm.

The width D of the light transmission region 144 corresponding to a first step (Sx1) is 120 nm, and in this case, the remaining resist film thickness R is 3.3 μm.

Note that in this case, the exposure conditions are preferably set such that the numerical aperture NA is 0.5, the coherence factor σ is 0.5, and the reduced projection magnification is 5.

Using a photomask in which mask cells are arranged appropriately such that an amount of transmission light corresponding to each portion of the desired resist shape is obtained, a stepped resist pattern having seven gradations, for example, such as that described above, can be formed in a single exposure process.

### First Embodiment

1. Diffractive Optical Element

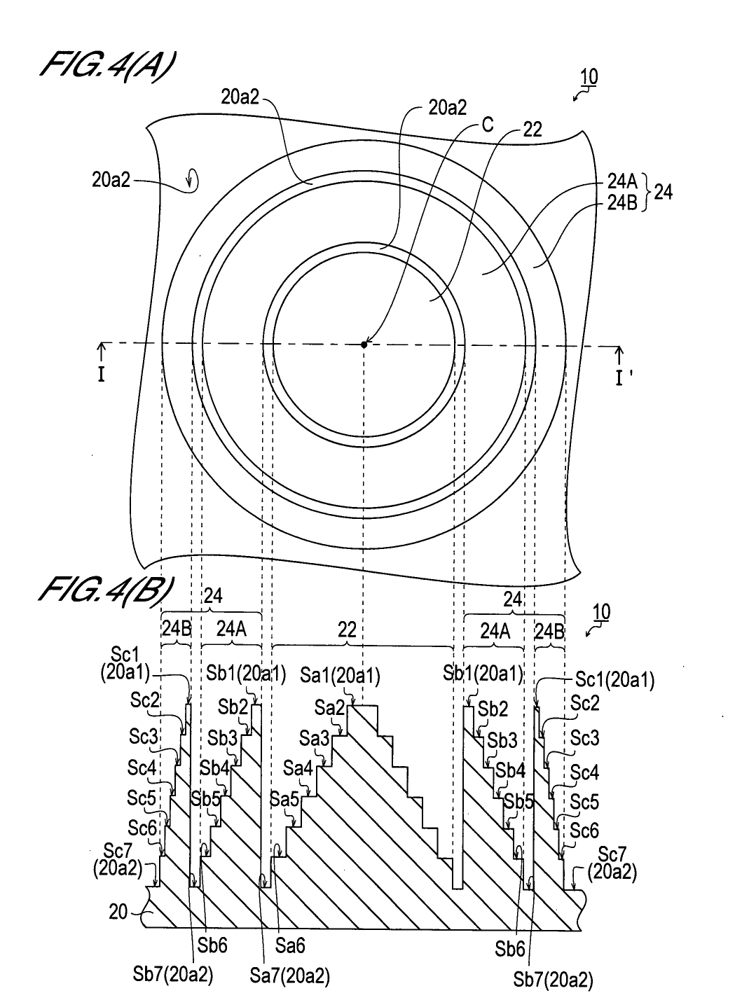

Referring to FIG. 4, a constitutional example of a diffractive optical element formed using the manufacturing method of the present embodiment will be described.

FIG. 4(A) is a schematic plan view showing a constitutional example of the diffractive optical element. FIG. 4(B) is a diagram showing schematically a sectional end surface taken along a straight line I-I′ that passes through the center of the diffractive optical element shown in FIG. 4(A). Note that in FIG. 4(A), the stepped portions appearing in the end surfaces shown in FIG. 4(B) have been omitted. That is, lines showing boundaries between the stepped portions are not shown in FIG. 4(A).

In the constitutional example shown in FIGS. 4(A) and 4(B), a diffractive optical element 10 is formed by being engraved in a substrate 20 of a silicon wafer, for example. The diffractive optical element 10 takes the form of a so-called Fresnel lens.

The diffractive optical element 10 comprises a portion 22 that varies in film thickness from a central point C toward the outer periphery thereof in m steps, or seven steps in this example.

The portion 22 has a circular shape when seen from above, and in the sectional form thereof, a primary surface 20a1 including the center C is set as a columnar first step (Sa1) having the greatest height, a secondary surface 20a2 generated by an etching process to be described below is set as a seventh step (Sa7) having the lowest height, and six annular steps (Sa2, Sa3, Sa4, Sa5, Sa6, and Sa7) are provided so as to surround the periphery of the first step (Sa1). The seventh step (Sa7) matches the secondary surface 20a2. Hence, the surface of the portion 22 is a seven-step, annular-stepped structure which, by means of the plurality of steps, as a whole approximates a substantially conical surface-shaped curved surface.

As shown in Table 2, in this example the height differences between adjacent steps of the resist pattern, or in other words the diffractive optical element, are all equal. However, by modifying the surface area of the light-shielding region 142 of the photomask appropriately within an allowable range, as described above, the height differences between adjacent steps of the resist pattern, or in other words the diffractive optical element, may be varied. For example, by making the light intensity of the light transmitted through the mask cells for forming the first to seventh steps more than twice the light intensity of the previous step, a surface approximating a substantially spherical crown-shaped curved surface as a whole can be obtained.

Furthermore, in this example, each step (Sa2, Sa3, Sa4, Sa5 and Sa6), excluding the first step (Sa1) and the seventh step (Sa7), has an identical surface area, but the present invention is not limited to this example.

More specifically, by appropriately modifying the arrangement (arrangement shape and number) of the mask cells 140 of the photomask within an allowable range, the surface area of these steps (Sa2, Sa3, Sa4, Sa5 and Sa6) and the surface area of the first step (Sa1) and seventh step (Sa7) can be adjusted arbitrarily and favorably.

For example, the surface area of the steps (Sa2, Sa3, Sa4, Sa5 and Sa6) can be varied so as to become steadily smaller toward the outer periphery.

The diffractive optical element 10 further comprises a plurality of wall-like structural units 24 which may be formed as cylindrical ones. Each structural unit 24 surrounds the portion 22. The following will be given to the example in which the diffractive optical element 10 has a plurality of structural units 24. However, the diffractive optical element 10 may be a structure having a single structural unit 24, for example.

Hence, the plurality of structural units 24 is arranged concentrically about the central point C. In this example, the structural units 24 include two structural units, namely a first structural unit 24A and a second structural unit 24B. Note that the number of structural units 24 is not limited to this example, and the structural units 24 may be provided in an arbitrary number appropriate to the desired optical characteristics.

The first structural unit 24A is disposed on the common secondary surface 20a2 on the outside of the portion 22, and surrounds the portion 22 at a remove therefrom. The second structural unit 24B is disposed on the outside of the first structural unit 24A at a remove from the first structural unit 24A.

Similarly to the portion 22, the cylindrical structural units 24 become thinner in stepped fashion in the outer peripheral direction, and comprise a total of n steps. In this example, the n steps constitute a seven-step stepped form identical to the number of steps m in the portion 22 described above. In other words, a portion 22 side surface of the structural units is a circumferential surface that is perpendicular to the substrate surface. Further, a surface of the structural units on the opposite side of the portion 22 approximates a substantially conical surface or a substantially spherical crown-shaped curved surface, similarly to the surface of the portion 22 described above.

Here, m and n are arbitrary positive integers that are either identical or different to each other. In other words, the number of steps n of the structural units 24 and the number of steps m of the portion 22 may be identical or different to each other.

As regards the number of steps n of the structural units 24, when a plurality of structural units are provided, for example when the first structural unit 24A and second structural unit 24B are provided, the respective number of steps thereof may be identical or different.

In this example, the height of each step of the first structural unit 24A from a first step (Sb1) to a seventh step (Sb7), or in other words the height of Sb1, Sb2, Sb3, Sb4, Sb5, Sb6 and Sb7, corresponds to, or in other words is equal to, the height of its numerical counterpart in the portion 22, i.e. the steps Sa1, Sa2, Sa3, Sa4, Sa5, Sa6 and Sa7.

Similarly, in this example, the height of each step of the second structural unit 24B from a first step (Sc1) to a seventh step (Sc7), or in other words the height of Sc1, Sc2, Sc3, Sc4, Sc5, Sc6 and Sc7, corresponds to, or in other words is equal to, the height of its numerical counterpart in the portion 22, i.e. the steps Sa1, Sa2, Sa3, Sa4, Sa5, Sa6 and Sa7, and the height of its numerical counterpart in the first structural unit 24A, i.e. the steps Sb1, Sb2, Sb3, Sb4, Sb5, Sb6 and Sb7.

However, the height of each step in the first structural unit 24A and the height of each numerically corresponding step in the portion 22 may be made different.

In the diffractive optical element, the surface area of the numerically corresponding steps in the portion 22 and the structural units 24 is preferably set to decrease steadily toward the outer periphery.

Likewise in this example, the surface area of each step in the portion 22, the surface area of each step in the first structural unit 24A, and the surface area of each step in the second structural unit 24B decrease steadily, i.e. in this order, toward the outer periphery.

As described above, by modifying the arrangement (arrangement, shape and number) of the mask cells 140 of the photomask appropriately within an allowable range, the surface area of each step can be set arbitrarily and favorably.

2. Diffractive Optical Element Manufacturing Method

A diffractive optical element manufacturing method according to the present embodiment will be described below with reference to the drawings.

Here, it is assumed that a diffractive optical element having the structure described as an example with reference to FIGS. 4(A) and 4(B) is manufactured.

As described above, the diffractive optical element has a stepped portion that decreases in thickness from the center toward the outer periphery in m steps. Further, a plurality of wall-like structural units is provided so as to surround the portion concentrically. In this constitutional example shown in FIGS. 4(A) and (B), the wall-like structural units 24 are formed as cylindrical ones. The maximum thickness of both the portion and each structural unit from a reference surface is equal. Each structural unit is structured such that the thickness thereof decreases from a portion side outward in a radial direction in n steps.

This manufacturing method employs exposure and development processes using a photomask having the structure described above, and uses a resist pattern formed in the exposure and development processes as a mask.

Accordingly, in the following description, conventional processes are not illustrated, and detailed description thereof has been omitted.

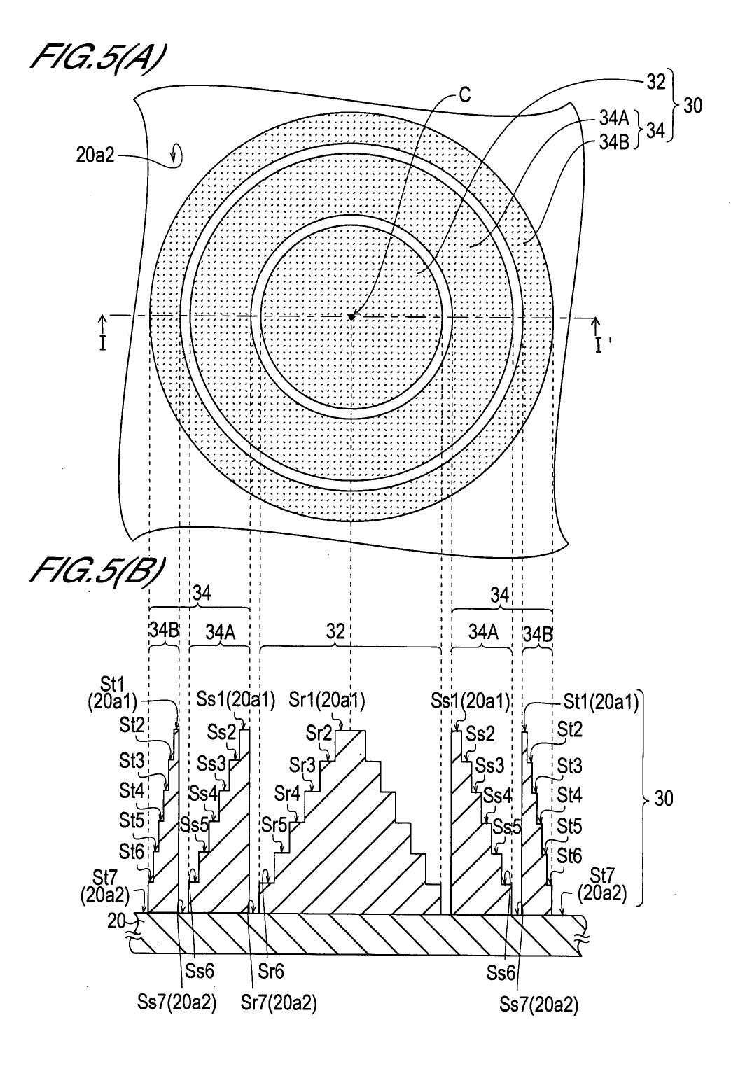

FIG. 5(A) is a schematic plan view showing constitutional example of resist structural units, and FIG. 5(B) is a schematic diagram showing a sectional end surface cut along a straight line I-I′ that passes through the center of the resist structural units shown in FIG. 5(A). In the example to be described below, a silicon substrate is used as a substrate and the diffractive optical element is a so-called silicon microlens. Further, in this example, it is assumed that m=n=7.

First, the parallel plate form substrate 20 is prepared. The substrate 20 comprises the primary surface 20a1 and a second surface (to be referred to simply as a rear surface) 20b opposing the primary surface 20a1. A lens formation region is previously set on the primary surface 20a1.

The substrate 20 applied to the present embodiment is not limited to a silicon substrate, and various types of substrate, such as a glass substrate, a germanium substrate, and an InP substrate, may be used favorably.

Next, the primary surface 20a1 of the substrate 20 is coated with a resist material of a positive type in this example, for example the aforementioned resist material A.

The resist material may be coated by using a conventional spin coater.

Next pre-bake processing is performed on the substrate 20 coated with the resist material. The pre-bake processing is preferably performed under conditions corresponding to the selected resist material. When the resist material A is used, pre-bake processing is preferably performed for 60 seconds at an atmospheric temperature of 90° C., for example.

Next, exposure processing is performed in a photolithography process.

A photomask having the structure described below is used in the exposure processing. In other words, according to the manufacturing method of the present embodiment, a resist pattern is formed in a single exposure process using this photomask.

In the exposure process, the light intensity of the light transmitted through the mask cells 140 is set at the normalized light intensity described above.

Further, for forming a diffractive optical element with the above mentioned type structure, such resist pattern is required that has a resist structure and at least one resist structural units. Therefore, when the light intensity that contributes to formation of the respective first steps of the resist structure and the resist structural units is a first light intensity, and the light intensity that contributes to formation of the respective final steps of the resist structural units is a final step light intensity, the mask cells are arranged such that the light intensity increases in stepped fashion by discrete values from the first light intensity to the final step light intensity.

By setting the respective light intensities of the light passing through the respective mask cells of the photomask to have the relationship described above, a resist pattern such as that described above, in which the film thickness of the resist structure and resist structural units varies in stepped fashion, can be formed.

When this type of photomask is used, the exposure light of the resist that passes through the photomask has a circular exposure pattern forming the portion and a plurality of annular exposure patterns surrounding the portion at concentric intervals. The respective light intensities of the circular and annular exposure patterns vary in stepped fashion from the first light intensity to the final step light intensity. Hence, in the structural example shown in the drawings, when the light intensity of the exposure light of the mask cells corresponding to the final step is set as an Xth intensity, the magnitude relationship between the first light intensity and the Xth light intensity is 0≦first light intensity< . . . <Xth light intensity≦1. Furthermore, in the example described here, the rate of change in the light intensity, or in other words the increment size, is identical at each step.

When exposure processing is performed using the i-line stepper A described above, for example, exposure processing is preferably performed for 280 milliseconds, for example.

Post-exposure baking processing is performed next. In the embodiment described above, post-exposure baking processing is preferably performed for 100 seconds at an atmospheric temperature of 110° C., for example.

By employing this photomask, a complicated resist pattern shape such as that described above, including a plurality of steps or a curved surface approximated by the plurality of steps, can be formed with an extremely high degree of precision in a single exposure process.

Next, development processing is performed using a developer. An arbitrary developer suitable for the selected resist material may be used. When the resist material A is used, development processing is preferably performed for 90 seconds using NMD-3 (product name), manufactured by Tokyo Ohka Kogyo Co., Ltd, which is an alkaline developer, for example.

Next, post-development baking processing is performed under arbitrary conditions suitable for the selected materials. When the resist material A is used, post-development baking processing is preferably performed for 100 seconds at an atmospheric temperature of 120° C., for example, and in so doing, a resist pattern 30 having the structure shown in FIGS. 5(A) and 5(B) is obtained.

The resist pattern 30 is formed as a pattern having a shape that resembles the structure to be formed, i.e. the portion 22 and structural units 24 of the diffractive optical element described above. More specifically, the planar size of the resist pattern 30 when seen from above is identical to that of the desired structure. Further, the three-dimensional shape of the resist pattern 30, or in other words the size of the resist pattern in the thickness direction of the substrate 20, does not need to be identical in size to the desired structure. The size of the resist pattern in the thickness direction of the substrate 20, or in other words the depth that is removed by etching, can be adjusted in accordance with the etching rate, and therefore the three-dimensional shape of the resist pattern 30 may be formed in a suitable size conforming to the selected etching rate.

More specifically, the resist pattern 30 has a resist structure 32 having a film thickness that varies from the central point C toward the outer periphery in m steps, or in this example a stepped resist structure 32 that varies in seven steps, with the primary surface 20a1 exposed from the resist pattern 30 serving as the seventh step.

The resist structure 32 has a circular shape when seen from above, and the sectional form thereof comprises a columnar first step (Sr1), which includes the center C and is located at the highest height position, and six annular steps (Sr2, Sr3, Sr4, Sr5, Sr6, and Sr7) provided so as to surround the periphery of the first step (Sr1).

As a result, the surface of the resist structure 32 approximates a curved surface on a substantially conical plane as a whole by means of the plurality of steps. Note that the seventh step (Sr7) formed after etching, or in other words the part that corresponds to the final step in the lowest height position following etching, corresponds to the exposed surface of the primary surface 20a1 of the substrate 20.

In this example, as described above, the rate of change in the light intensity, or in other words the increment size, is identical at each step. Hence, the height differences between adjacent steps are also equal. However, by modifying the surface area of the light-shielding region 142 of the photomask appropriately to alter this rate of change, the height differences between adjacent steps can be varied. For example, as regards the increment size in the light intensity of the exposure light for forming each step, the rate of change in the light intensity of a certain step can be increased gradually from the rate of change in the light intensity of the previous step from the first step to the seventh step. In this case, the surface of the formed resist structure 32 can be made to approximate a substantially spherical crown-shaped curved surface.

Further, in this example, each step (Sr2, Sr3, Sr4, Sr5 and Sr6), excluding the first step (Sr1), has an identical surface area.

In other words, by appropriately modifying the arrangement (arrangement shape and number) of the mask cells 140 of the photomask within an allowable range, the surface area of these steps (Sr2, Sr3, Sr4, Sr5 and Sr6) and the surface area of the first step (Sr1) and seventh step (Sr7) can be adjusted arbitrarily and favorably.

For example, the surface area of the steps (Sr2, Sr3, Sr4, Sr5 and Sr6) can be made different to each other.

The resist pattern 30 comprises a plurality of wall-like resist structural units 34. In this example, the resist structural units 34 are formed as annular ones. Each resist structural unit 34 surrounds the resist structure 32.

The plurality of resist structural units 34 are arranged concentrically about the central point C. In this example, the resist structural units 34 include two resist structural units, namely a first resist structural unit 34A and a second resist structural unit 34B. Note that the number of resist structural units 34 is not limited to this example, and the structural units 34 may be provided in a desired arbitrary number of one or more.

The first resist structural unit 34A is disposed on the outside of the resist structure 32, and surrounds the portion 32 at a remove therefrom.

The second resist structural unit 34B is disposed on the outside of the first resist structural unit 34A at a remove from the first resist structural unit 34A.

Thus, the primary surface 20a1 of the substrate 20 is exposed between the resist structure 32 and the first resist structural unit 34A, and between the first resist structural unit 34A and second resist structural unit 34B.

Similarly to the resist structure 32, the annular resist structural units 34 take a stepped form in which the thickness thereof decreases in the outer peripheral direction in n steps, or in this example seven steps, which is identical to the number of steps m of the resist structure 32 described above. Note, however, that the seventh step is the primary surface 20a1 of the substrate 20. The surface of the resist structural unit 34 on the opposite side to the resist structure may be made to approximate a substantially conical surface or a substantially spherical crown-shaped surface, similarly to the surface of the resist structure described above.

Here, m and n are arbitrary positive integers that are either identical or different to each other. In other words, the number of steps n of the resist structural units 34 and the number of steps m of the portion 22 can be formed in a single exposure process, regardless of whether the numbers are identical or different to each other.

Further, as regards the number of steps n of the resist structural units 34, when a plurality of structural units are provided, for example when the first resist structural unit 34A and second resist structural unit 34B are provided, the respective number of steps thereof can be formed in a single exposure process, regardless of whether the numbers are identical or different to each other.

In this example, the height of each step of the first resist structural unit 34A from a first step (Ss1) to a sixth step (Ss6), or in other words the height of Ss1, Ss2, Ss3, Ss4, Ss5 and Ss6, corresponds to, or in other words is equal to, the height of its numerical counterpart in the resist structure 32, i.e. the steps Sr1, Sr2, Sr3, Sr4, Sr5 and Sr6.

Similarly, in this example, the height of each step of the second resist structural unit 34B from a first step (St1) to a sixth step (St6), or in other words the height of St1, St2, St3, St4, St5 and St6, corresponds to, or in other words is equal to, the height of its numerical counterpart in the resist structure 32, i.e. the steps Sr1, Sr2, Sr3, Sr4, Sr5 and Sr6, and the height of its numerical counterpart in the first structural unit 34A, i.e. the steps Ss1, Ss2, Ss3, Ss4, Ss5 and Ss6.

However, the height of each step in the first resist structural unit 34A and the height of each numerically corresponding step in the resist structure 32 may be made different.

In the diffractive optical element, as described above, the surface area of the numerically corresponding steps in the portion 22 and the structural units 24 is generally set to decrease steadily toward the outer periphery.

The planar form of the resist pattern 30 seen from above is transferred onto the substrate 20 substantially as is. Hence, in the resist pattern 30 also, the surface area of each step in the resist structure 32, the surface area of each step in the first resist structural unit 34A corresponding thereto, and the surface area of each step in the second resist structural unit 34B corresponding thereto decrease steadily, i.e. in this order, toward the outer periphery.

As described above, by modifying the arrangement, or in other words the arrangement shape and number, of the mask cells 140 of the photomask appropriately within an allowable range, the surface area of each step of the resist pattern 30 can be set arbitrarily and favorably.

By performing a photolithography process on the resist material that is applied to the substrate 20 using the photomask described above, the resist pattern 30 can be formed with patterned surfaces having a plurality of different depths.

Patterning is performed in accordance with a normal method, using the resist pattern 30 as an etching mask.

In the patterning process, the resist pattern 30 is cut and the shape thereof is transferred onto the silicon substrate 20.

The patterning process is performed while etching the resist pattern 30 by means of anisotropic etching from a perpendicular direction to the substrate surface. As the etching progresses, the outline form of the resist pattern 30 moves in parallel such that the low parts (steps) of the resist pattern 30 are removed in order of the parts of the substrate 20 to be gradually exposed, whereby a pattern is gradually formed.

More specifically, at the same time as etching begins, the primary surface 20a1 corresponding to the seventh step, which is an exposed surface from the resist pattern 30, is removed. As etching progresses, the sixth step, fifth step, fourth step, third step and second step of the resist pattern 30 are removed in this order, and thus etching is performed gradually more deeply toward the parts corresponding to steps at which the exposure timing of the primary surface 20a1 is earliest.

Etching is halted at the same time as the first step of the resist pattern 30 is etched, or in other words at the point where the first step of the resist pattern 30 is removed.

Hence, the primary surface 20a1 positioned directly beneath the first step of the resist pattern 30 remains. Here, a surface serving as a new surface of the substrate 20, which is etched most deeply and corresponds to the seventh step of the portion 22 and structural unit 24, forms the secondary surface 20a2.

This patterning process is preferably performed using a well-known etching apparatus comprising an RF (radiofrequency) power source, for example. At this time, a mixed gas containing SF₆ gas and O₂ gas is preferably used as an etchant.

Note that the height of each step of the to be formed portion 22 and structural unit 24 may be set at an arbitrary predetermined height by adjusting the etching rate, rather than simply at the height of each step of the resist pattern 30.

Next, a further photolithography process and etching process, or in other words a patterning process, may be performed to cut out a diffractive optical element having a desired shape.

According to the manufacturing method for an optical element of the present embodiment, an optical element in which a plurality of stepped structural units are arranged in series can be manufactured simply by a process for forming a stepped resist mask including a plurality of steps through a single exposure process and development process, and substrate patterning by means of a single etching process employing the resist mask. In other words, an optical element can be manufactured by an extremely simple process.

### Second Embodiment

1. Diffractive Optical Element

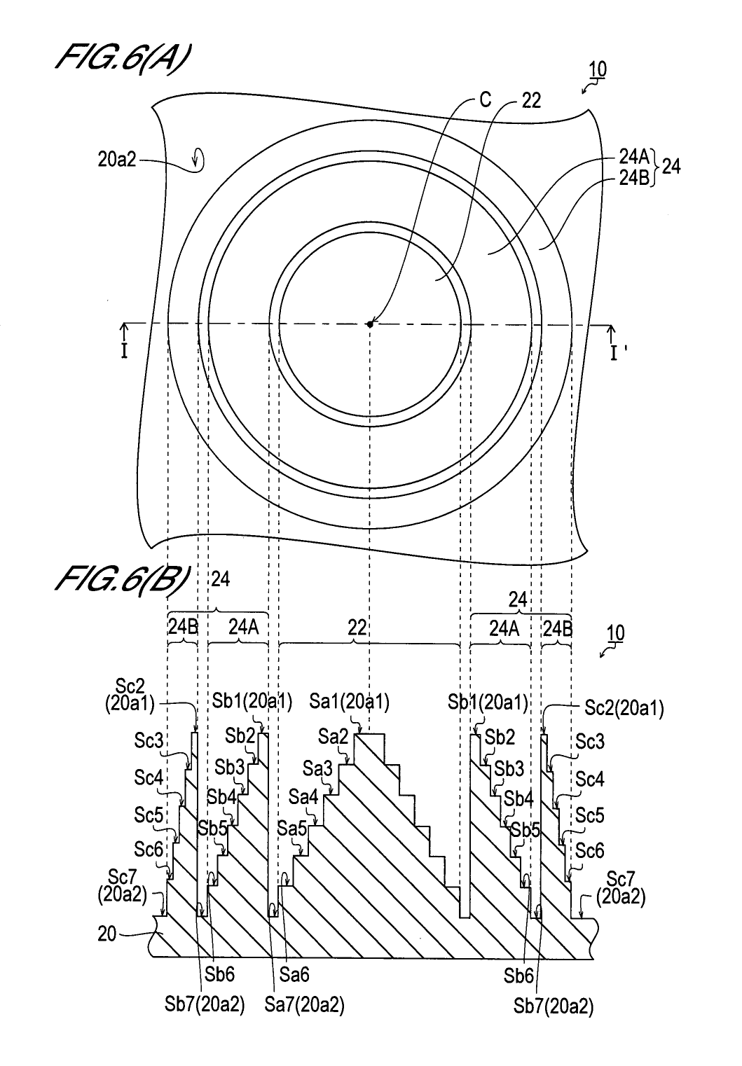

Referring to FIG. 6, a constitutional example of a diffractive optical element formed by a manufacturing method according to an embodiment of the present invention will be described.

FIG. 6(A) is a schematic plan view of the diffractive optical element, and FIG. 6(B) is a schematic diagram schematically showing a sectional end surface taken along a straight line I-I′ that passes through the center of the diffractive optical element shown in FIG. 6(A).

In the diffractive optical element of this example, the number of steps in the portion 22 and the number of steps in the stepped structure of the structural unit 24 are different. All other structures are similar to those of the first embodiment described above, and hence detailed description thereof has been omitted.

In the constitutional example shown in FIGS. 6(A) and 6(B), the diffractive optical element 10 comprises the portion 22, the film thickness of which varies in stepped form from the central point C toward the outer periphery in m steps, i.e. seven steps in this example.

Similarly to the portion 22, the cylindrical structural units 24 decrease in thickness in the outer peripheral direction by n steps. In this example, the number of steps of the first structural unit 24A is identical to the number of steps m in the portion 22 described above, i.e. 7.

Further, in this example the second structural unit 24B has one less step than the first structural unit 24A, i.e. 6.

Hence, in this example, the number of steps n includes a plurality of step numbers (numerical values), and the number of steps m may be different to the number of steps n.

Similarly to the first embodiment, in this example the height of each step from-the first step (Sb1) to the seventh step (Sb7) of the first structural unit 24A, or in other words the height of Sb1, Sb2, Sb3, Sb4, Sb5, Sb6 and Sb7, corresponds to, or in other words is equal to, the height of its numerical counterpart in the portion 22, or in other words Sa1, Sa2, Sa3, Sa4, Sa5, Sa6 and Sa7.

Hence, the overall height of the first structural unit 24A and the overall height of the portion 22, or in other words the height or level of the first step (Sa1) are equal.

On the other hand, the first step (Sc2) of the second structural unit 24B is set to be equal to the overall height or level of the portion 22, or in other words the height or level of the first step (Sa1). Further, the sixth step (Sc7) of the second structural unit 24B is equal in height or level to the seventh step (Sa7) of the portion 22.

Further, in this example, the height of each step from the second step (Sc3) to the fifth step (Sc6) of the second structural unit 24B, or in other words the height or level of Sc4, Sc5 and Sc6, is different to its numerical counterpart in the portion 22.

More specifically, Sc6 exists at a height between Sb6 and Sb5. Sc5 exists at a height between Sb5 and Sb4. Sc4 exists at a height between Sb4 and Sb3. Sc3 exists at a height between Sb3 and Sb2.

Accordingly, the overall height of the first structural unit 24A, or in other words the height or level of the first step (Sb1), and the overall height of the second structural unit 24B, or in other words the height or level of the first step (Sc2), is set to be substantially identical.

In this example, both the portion 22 and the first structural unit 24A have seven steps, while the second structural unit 24B has six steps. However, the present embodiment is not limited to this example.

For example, structural units having gradually smaller numbers of steps, i.e. five steps, four steps, and so on, for example, may be provided on the outside of the second structural unit 24B.

This type of constitution is effective when a region in which the line width of a single phase becomes smaller than the mask pitch exists, for example.

Thus, in the diffractive optical element manufactured by the manufacturing method of the present embodiment, the number of steps provided on the stepped structures included therein, i.e. the portion and the structural units, may be set arbitrarily so as to be identical or different to each other.

2. Diffractive Optical Element Manufacturing Method

A manufacturing method for the diffractive optical element according to this embodiment will now be described.

This manufacturing method employs exposure and development processes using a photomask having the structure described above, and uses a resist pattern formed in the exposure and development processes as a mask for forming the portion 22 and second structural unit 24B to have a different number of steps to the first structural unit 24A.

In other words, the manufacturing method of this example is identical to that of the first embodiment described above except for the shape of the formed resist pattern. Therefore, detailed description and illustration of parts other than this process have been omitted, and shared constitutional elements have been allocated reference symbols corresponding to the constitutional elements of the first embodiment.

First, similarly to the first embodiment described above, the substrate 20 is prepared, coated with resist material, and subjected to pre-bake processing.

Next, the exposure processing of the photolithography process is performed.

A photomask having the mask cell constitution described above is used during the exposure processing. In other words, according to the manufacturing method of the present embodiment, a resist pattern is formed in a single exposure process employing a photomask.

In the exposure process, the light intensity of the light that is transmitted through the mask cells 140 is normalized in the manner described above.

Further, similarly to the first embodiment described above, when the light intensity contributing to the formation of the respective first steps of the resist structure and the wall-like resist structural units is set as a first light intensity and the light intensity contributing to the formation of the respective final steps of the resist structural units is set as a final step light intensity, the mask cells are arranged such that the light intensity increases in steps, by discrete values, from the first light intensity to the final step light intensity.

By setting the light intensity of the light that is transmitted through the respective mask cells of the photomask to have the relationship described above, a resist pattern such as that described above, having a resist structure and resist structural units that vary in film thickness in a stepped fashion, can be formed.

When this photomask is employed, the exposure light that is transmitted through the photomask comprises a circular exposure pattern forming the portion, and a plurality of annular exposure patterns surrounding the portion concentrically and at a remove from each other.

In each of the circular and annular exposure patterns, the light intensity varies in stepped fashion from the first light intensity to the light intensity of the final step.

Hence, in this constitutional example, when the light intensity of the exposure light of a mask cell corresponding to a final step X is an Xth light intensity, the magnitude relationship between the first light intensity and the Xth light intensity is 0≦first light intensity< . . . <Xth light intensity≦1.

The light intensity of transmission light corresponding to the same step as that of an Mth light intensity, which is the light intensity of a mask cell for forming an Mth step in the middle of the resist structure and resist structural units, may be different or identical to one or both of the light intensities of transmission light corresponding to the same step in the plurality of resist structural units. There may be formed a resist structure with m steps, resist structural units with m steps and another resist structural units with n steps.

As regards the light intensity of the light that is transmitted through the plurality of mask cells 140 in this embodiment, the light intensity of the light that is transmitted through the plurality of mask cells 140 may be set as follows. The light intensity of the mask cells that contribute to the formation of the height of the central point C of the resist structure and of the first step of the resist structural units may be set as a first light intensity. When X is a maximum value of the number of steps m of the resist structure and the number of steps n of the resist structural units, the light intensity of all of the mask cells contributing to the formation of the height of the step(s) comprising one or more steps and being outside of the first step, and the last Xth step may be set as an Xth light intensity (where the magnitude relationship from the first light intensity to the Xth light intensity is 0≦first light intensity< . . . <Xth light intensity≦1). A Yth light intensity of a Yth step, which is a final step of another resist structural units (Y is a positive integer smaller than X of the number of steps m of the resist structure), may be set to be equal to the Xth light intensity, and the light intensity of a highest step may be set at the first light intensity.

Next, post-exposure bake processing is performed.

By employing such photomask, the plurality of steps described above or the resist pattern surface formed by the plurality of steps can be made to approximate various complex curved surface forms. Moreover, an extremely precise resist pattern shape can be obtained by a single exposure process.

The resist pattern is formed in a pattern having a substantially identical shape or a similar shape to the structure to be formed, i.e. the portion 22 and structural units 24 described above. More specifically, the planar size of the resist pattern when seen from above is identical to that of the structure to be manufactured. The three-dimensional shape of the resist pattern, or in other words the size of the resist pattern in the thickness direction of the substrate 20, does not have to be identical to that of the structure to be manufactured. The size of the resist pattern in the thickness direction of the substrate 20, or in other words the depth to be removed by etching, may be adjusted in accordance with the etching rate, and therefore the three-dimensional shape of the resist pattern may be formed in an appropriate size corresponding to the selected etching rate.

In other words, the resist pattern has a resist structure, the film thickness of which varies in stepped fashion from a central point to the outer periphery in m steps. In other words, in this example, the resist pattern has a resist structure that varies in film thickness in a seven-step stepped fashion, with the primary surface 20a1 exposed from the resist pattern serving as the seventh step.

The resist structure takes a circular shape when seen from above, and the sectional form thereof comprises a columnar first step located in the highest height position and including the central point C, and six cylindrical steps provided so as to surround the periphery of the first step.

As a result, the surface of the resist structure approximates a substantially conical surface or spherical crown-shaped curved surface as a whole by means of the plurality of steps. Note that the seventh step formed when etching is complete, or in other words the part that corresponds to the final step located in the lowest height position following etching, corresponds to the exposed surface of the primary surface 20a1 of the substrate 20.

In this example, the height differences between adjacent steps are all identical. However, the height differences between adjacent steps may be made different by modifying the surface area of the light-shielding region 142 of the photomask, described above, appropriately to vary the rate of change therein.

Further, the surface area of each step excluding the first step is identical.

More specifically, the surface area of each step and the surface areas of the first step and seventh step may be determined arbitrarily and favorably by modifying the arrangement of the mask cells 140 of the photomask, i.e. the arrangement shape and number of mask cells, appropriately within an allowable range.

For example, the surface area of each step may be made different.

The resist pattern includes a plurality of wall-like, here cylindrical resist structural units. Each resist structural unit surrounds the resist structure.

The plurality of resist structural units is arranged concentrically about the central point. In this example, the resist structural units include two resist structural units, i.e. a first resist structural unit and a second resist structural unit. Note that the number of resist structural units is not limited to the illustrated example, and may be set arbitrarily at a desired number.

The first resist structural unit is disposed on the outside of the resist structure, and surrounds the resist structure at a remove therefrom.

The second resist structural unit is disposed on the outside of the first resist structural unit and at a remove from the first resist structural unit.

Thus, the primary surface 20a1 of the substrate 20 is exposed between the resist structure and the first resist structural unit, and between the first resist structural unit and second resist structural unit.

Similarly to the resist structure, the second structural unit of the cylindrical resist structural units has a stepped structure in which the thickness thereof decreases in n steps in the outer peripheral direction. In this example, the second resist structural unit has seven steps, i.e. an identical number of steps to the step number m of the resist structure. Similarly, the first structural unit has a structure of seven steps. Note, however, that the seventh step of the first structural unit, as well as the seventh step of the first resist structural unit and the portion, is the primary surface 20a1 of the substrate 20.

In this example, the height of each step of the first resist structural unit preferably corresponds to, or in other words is preferably equal to, the height of the corresponding step of the resist structure.

Further, in this example the height of the second step through sixth step of the second resist structural unit is set to be different to the height of each step of the resist structure and first resist structural unit.

More specifically, the first step of the second resist structural unit is equal in height to the first step of the resist structure and the first resist structural unit, and the height of the sixth step of the second resist structural unit is equal to the height of the first step and seventh step of the resist central potion and the first resist structural unit.

Hence, in this example, the heights of the second through fifth steps of the second resist structural unit are set to be different to the height of each step of the resist structure and the first resist structural unit.

By performing a photolithography process on resist material applied to the substrate 20 using the photomask described above, a resist pattern having a patterned surface with a plurality of different depths is formed.

Patterning is then performed in accordance with a conventional method, using the resist pattern as an etching mask.

In the patterning process, the shape of the resist pattern is transferred onto the silicon substrate as the resist pattern is cut away.

More specifically, at the same time as etching begins, the primary surface 20a1 corresponding to the seventh step, i.e. the surface that is exposed from the resist pattern 30, is cut. As etching progresses further, the sixth step, fifth step, fourth step, third step, and second step of the resist pattern are removed in sequence, and thus etching is performed gradually more deeply toward the parts corresponding to steps at which the exposure timing of the primary surface 20a1 is earliest.

Etching is halted at the same time as the uppermost step of the resist pattern, which in this example is the first step of the resist structure and the second resist structural unit, is removed by etching, or in other words when the first step is removed.

Hence, the primary surface 20a1 positioned directly beneath the first step of the portion and the second resist structural unit remains. Here, the surface that is etched the deepest, which corresponds to the seventh step of the portion and structural unit and serves as a new surface of the substrate 20, forms the secondary surface 20a2.

This patterning process is preferably performed using a well-known etching apparatus comprising an RF, or in other words a frequency power source, for example. At this time, a mixed gas containing SF₆ gas and O₂ gas is preferably used as an etchant.

Note that the height of each step of the formed portion and structural units may be set at an arbitrary predetermined height by adjusting the etching rate, rather than simply at the height of each step of the resist pattern.

Next, a further photolithography process and etching process, or in other words a patterning process, may be performed to cut out a diffractive optical element having a desired shape.

According to the diffractive optical element manufacturing method of this example, a diffractive optical element can be manufactured simply by patterning a substrate in a single etching process, even when stepped structural units having different numbers of steps coexist on the diffractive optical element.

In the above mentioned embodiments according to the present invention, explanation is given to the constructions of the diffractive optical elements in which the outline thereof has the circular shape and the circular portion located at the center of the circular.

However, the present invention is not limited to the above embodiments. The diffractive optical element according to the present invention may be also formed as so-called decenter-type ones in which a (center) portion is offset from the center and structural units are arc-shaped walls, each surrounding the portion.

Further, in the above mentioned embodiments, explanation is given to such method as utilizing the resist pattern having the resist structure and the cylindrical resist structure units.

However, when the diffractive optical element has a single structural unit, the resist pattern should have a single resist structural unit.

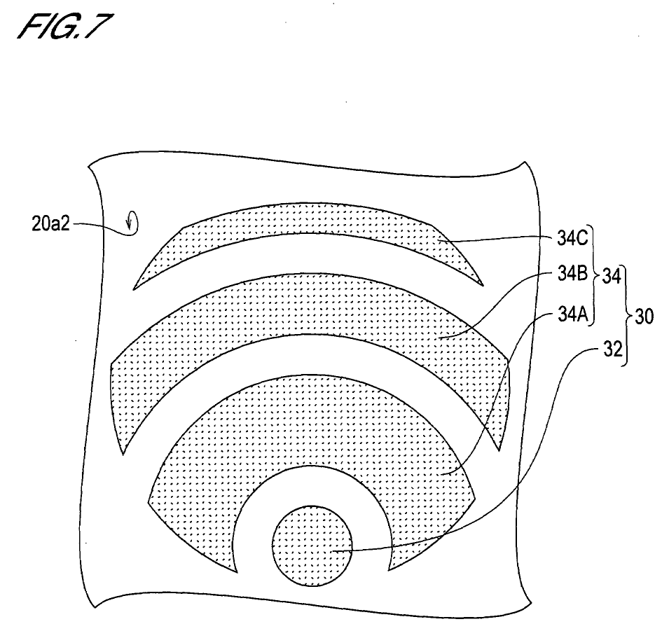

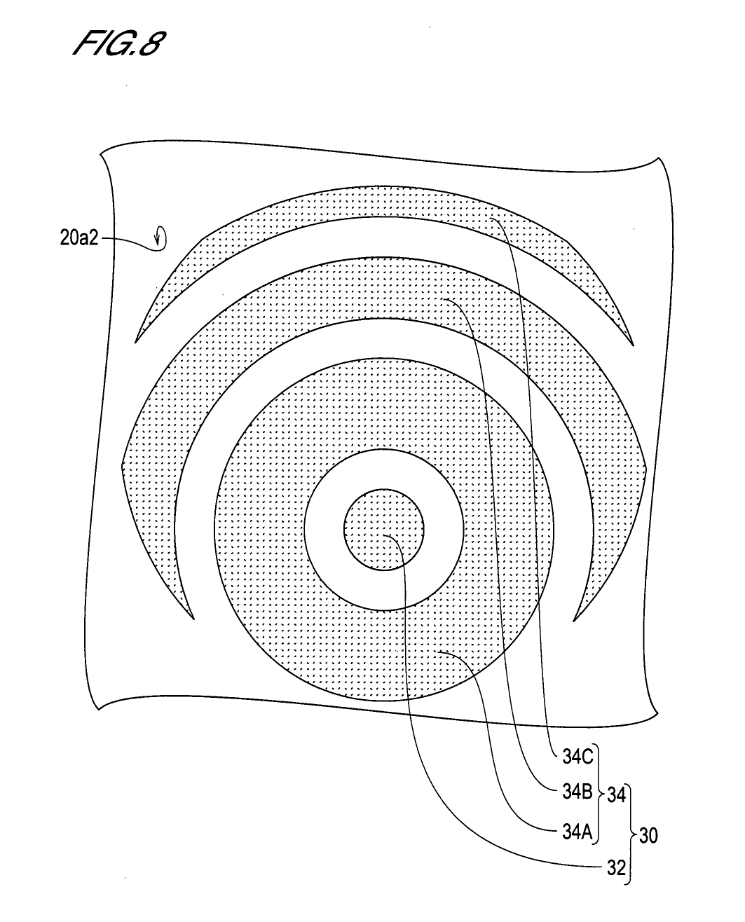

Further, in a case of the decenter-type diffractive optical element, as shown in FIG. 7, resist structural units 34 may be formed as arc walls 34A, 34B and 34C. Alternatively, as shown in FIG. 8, some of resist structural units 34 of plural ones may be arc walls 34B and 34C, and the residual one(s) may be circular wall(s) 34A. The planer shape of these resist structural units may depend on the structure of a to be formed diffractive optical elements.

What is claimed is:

1. A method for manufacturing an optical element, comprising the steps of:
preparing a substrate;
forming a resist pattern on said substrate by performing patterning including exposure processing using an exposure photomask for forming said resist pattern,
wherein said photomask comprises a mask substrate and a plurality of mask cells arranged in matrix form and in close contact with each other,
wherein each of said mask cells has one or both of a light transmission region and a light-shielding region formed by a light-shielding film provided at said mask substrate,
wherein a light intensity of light that is transmitted through said, mask cells is a normalized light intensity, and
wherein said light intensity of said light that is transmitted through said plurality of mask cells varies; and
performing patterning on said substrate using said resist pattern as an etching mask.

2. The method according to claim 1, wherein, when said resist pattern to be formed on said substrate has a pattern structure including a resist structure and at least one of wall-like cylindrical resist structural units provided concentrically on the outside of said resist structure so as to surround said resist structure, said resist pattern is formed using said photomask comprising said mask cells arranged such that when a light intensity contributing to the formation of a first step of said resist structure and a first step of said resist structural units is a first light intensity, and a light intensity contributing to the formation of a final step of each of said resist structural units is a final step light intensity, said light intensity varies in stepped fashion by discrete values from said first light intensity to said final step light intensity.

3. The method according to claim 2,
wherein when a light intensity of said mask cells for forming an intermediate Mth step provided in sequence on the outside of said first step is an Mth light intensity,
a light intensity relationship between said first step and said final step is set to satisfy 0≦first light intensity<second light intensity< . . . <M−1th light intensity<Mth light intensity<M+1th light intensity< . . . <final step light intensity≦1.

4. The method according to claim 2, wherein the number of steps of said resist structure and the number of steps of said respective resist structural units are set at different values, and wherein light intensities corresponding to an identical step to that of said Mth light intensity, which is a light intensity of said mask cell for forming said respective intermediate Mth steps of said resist structure and said resist structural units, are set at different values to each other.

5. The method according to claim 3, wherein the number of steps of said resist structure and the number of steps of said plurality of resist structural units are set identical to each other, both numbers of steps being set at seven.

6. The method according to claim 4, wherein the number of steps of said resist structure is set at seven, and wherein the number of steps of said resist structural units is set at six.

7. The method according to claim 2, wherein said resist pattern includes a single resist structure unit which is formed as a circular wall or an arc wall.

8. The method according to claim 2, wherein said resist pattern includes more than one resist structural units, and wherein said resist structural units are formed in one of following types:
(a) all resist structural units are circular type
(b) all resist structural units are arc type
(c) some of resist structural units are circular type and residual ones are arc type.

9. The method according to claim 1, wherein a length of one side of said mask cell is set to be shorter than a length serving as a resolution limit of an optical system of an exposure apparatus in which said photomask is used, and wherein said light intensity for said resist structure and each of said resist structural units is set at discrete values such that a rate of change therein between front and rear mask cells increases steadily in an outer peripheral direction.
